(19) United States
(12) Patent Application Publication
(10) Pub. No.: US 2003/0216246 A1
(43) Pub. Date: Nov. 20, 2003

(54) Transition metal complexes containing sulfur ligands, and polylefin production processes using them

(76) Inventors: Jessica A Cook, Clinton, NJ (US); John Joseph Bielak, South Amboy, NJ (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/380,590

(22) PCT Filed: Sep. 21, 2001
(86) PCT No.: PCT/US01/29563

(51) Int. Cl. C08F 4/44

(52) U.S. Cl. 502/104; 526/161; 526/172; 502/103; 502/117; 502/155; 502/168; 502/216; 502/219; 502/220; 502/222; 502/223

(57) ABSTRACT

A metal complex comprising a transition metal complex of a bidentate or tridentate, dithioether ligand having utility as a catalyst component of an olefin polymerization catalyst composition in combination with an activating co-catalyst.

The invention relates to a family of novel catalyst precursor compounds and compositions for the polymerization of olefins, including homopolymers of ethylene, propylene and other alpha-olefins and/or alpha olefin-dienes, as well as copolymers of alpha olefins, cyclic olefins and/or alpha olefin-dienes. In particular, the present invention provides catalyst precursor compounds and catalyst compositions which have good resistance to catalyst poisons, which can provide acceptable activity without the use of more expensive co-catalysts such as methyl alumoxane (MAO) or modified methyl alumoxane (MMAO), and which offer the possibility of polar comonomer incorporation into growing polymer chains.

Numerous metal complexes have been developed for use in forming catalyst compositions for polymerization of olefins to produce polyolefins. For example, Brookhart et al. have disclosed that late metals such as Ni, Pd, Fe and Co, when constrained in an appropriate ligand environment, are effective catalysts for the polymerization of ethylene (see, J. Am. Chem. Soc. 1996, 118, 267-268 and J. Am. Chem. Soc. 1995, 117, 6414-6415). According to Brookhart et al, the ability of the late metal Ni and Pd catalysts to polymerize rather than oligomerize ethylene is due to the steric bulk of the ligand, which prevents olefin approach at the axial sites, thus avoiding chain transfer to olefin. Brookhart et al. assert that the potential advantages offered by these catalysts include the incorporation of functionalized comonomers and the use of less expensive co-catalysts, such as diethyl aluminum chloride.

Despite these and other efforts, there remains an ongoing need for catalyst precursor compounds and compositions which enable various olefin polymerization reactions to be performed more efficiently, particularly at a lower cost with acceptable yield and activity. There is also an ongoing need for such catalyst precursor compounds which offer the possibility of polar comonomer incorporation into growing polymer chains. The catalyst compounds of the present invention, as well as catalyst compositions which contain the catalyst compounds of the present invention, and olefin polymerization reactions which employ the catalyst compounds of the present invention, as described below, satisfy these needs. The present invention provides a family of catalysts which are robust late transition metal complexes containing dithioether ligands.

The present invention provides transition metal complexes for use as catalyst precursors in olefin polymerization reactions comprising a bidentate or tridentate, dithioether ligand, said compounds corresponding to the formula:

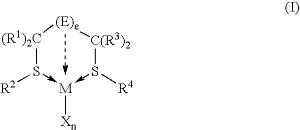

wherein:

E is a divalent ligand group containing one or more Group 14, 15 or 16 elements and optionally E may be bonded to M, said optional bond being indicated by →, and further optionally, (R¹)₂C-(E)e-C(R³)₂ collectively may be a 1,2-benzenediyl group;

e is 0 or 1;

M is a transition metal selected from groups 3-10 of the Periodic Table of the Elements, preferably Group 8;

R¹, R², R³ and R⁴ each occurrence are hydrogen, halogen, or a multiatomic group of up to 20 atoms not counting hydrogen, selected from the group consisting of hydrocarbyl; halocarbyl; halohydrocarbyl; hydrocarbyloxy; N,N-dihydrocarbylamino; N,N-hydrocarbyleneamino; dihydrocarbylphosphino; hydrocarbylenephosphino; trihydrocarbylsilyl; trihyhdrocarbylgermyl; and dihydrocarbylamino-, dihydrocarbylphosphino-, trihydrocarbylsilyl-, or trihalohydrocarbylsilyl- substituted derivatives thereof, and optionally R¹ may be joined to R², and further optionally R³ may be joined to R⁴, thereby forming ring structures;

X is a monovalent or divalent ligand group; and

n is an integer from 2 to 4 selected to provide charge balance.

In addition the present invention provides a di(thioether) compound suitable for use in preparing the foregoing metal complexes, said compound corresponding to the formula:

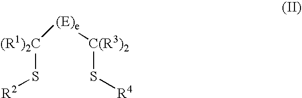

wherein:

E is a divalent ligand group containing one or more Group 14, 15 or 16 elements and optionally (R¹)₂C-(E)e-C(R³)₂ collectively may be a 1,2-benzenediyl group;

e is 0 or 1; and

R¹R² R³ and R⁴ each occurrence are hydrogen, halogen, or a multiatomic group of up to 20 atoms not counting hydrogen, selected from the group consisting of hydrocarbyl; halocarbyl; halohydrocarbyl; hydrocarbyloxy; N,N-dihydrocarbylamino; N,N-hydrocarbyleneamino; dihydrocarbylphosphino; hydrocarbylenephosphino; trihydrocarbylsilyl; trihyhdrocarbylgermyl; and dihydrocarbylamino-, dihydrocarbylphosphino-, trihydrocarbylsilyl-, or trihalohydrocarbylsilyl- substituted derivatives thereof, and optionally R¹ may be joined to R², R³ may be joined to R⁴, thereby forming ring structures.

The present invention also provides a method of forming a transition metal complex of formula (I) by contacting a transition metal compound of the formula MXₙ with from 1 to 3 moles per mole of transition metal compound of a di(thioether) compound of formula (II) at a temperature from −100 to 100° C. in an inert diluent, and optionally, in the presence of polymerizable monomers. The resulting transition metal complex may be recovered and purified if desired.

The present invention also provides a catalyst composition comprising a metal complex of formula (I) and from 1 to 1000 moles per mole of transition metal complex of an activating co-catalyst. The metal complex and activating cocatalyst may be combined in the presence of one or more olefin monomers or precontacted to form an active polymerization catalyst composition prior to contacting with one or more polymerizable olefin monomers.

The present invention further provides a process for producing an olefin polymer, which comprises contacting at least one olefin monomer under polymerization conditions with a catalyst composition comprising a metal complex of formula (I) and from 1 to 1000 moles per mole of transition metal complex of an activating cocatalyst.

Finally, the present invention provides a catalyst composition comprising a metal complex of formula (I) and from 1 to 1000 moles per mole of transition metal complex of an activating co-catalyst, in which the transition metal complex and the activating co-catalyst are introduced to a polymerization reactor at different locations.

The polymers produced according to the present invention are usefully employed in the preparation of various products, including blown and cast films for use in packaging and shrink-wrap applications, extrusion coatings, wire and cable insulation and jacketing, crosslinked power cable insulation, molded articles made by injection molding, blow molding or rotational molding, extrusions of pipe, tubing, profiles and sheeting, and insulating and semiconductive jacketing and/or shields.

All reference to the Periodic Table of the Elements herein shall refer to the Periodic Table of the Elements, published and copyrighted by CRC Press, Inc., 1999. Also, any reference to a Group or Groups shall be to the Group or Groups as reflected in this Periodic Table of the Elements using the IUPAC system for numbering groups. The contents of any patent, patent application or publication referenced herein are hereby incorporated by reference in their entirety herein, especially with respect to the disclosure of organometallic structures, synthetic techniques and general knowledge in the art. As used herein the term “aromatic” or “aryl” refers to a polyatomic, cyclic, ring system containing (4δ+2) π-electrons, wherein δ is an integer greater than or equal to 1. The term “comprising” and derivatives thereof, when used herein with respect to a composition, mixture, or sequence of steps, is not intended to exclude the additional presence of any other compound, component or event. The expression “copolymer” (and other terms incorporating this root), as used herein, refers to polymers formed by polymerizing two or more monomers. The term, “precursor” refers to a transition metal complex that may be combined with an activator compound to form a compound, composition or derivative that is active as an addition polymerization catalyst.

Preferred R² and/or R⁴ groups include aryl groups of from 6 to 20 carbons, especially bulky aryl groups, such as 2,4,6-triisopropylphenyl, 2,6-dilsopropylphenyl, 2,6-di-t-butylphenyl, and 2,4,6-trimethylphenyl. M is preferably selected from among Ni, Pd, Co, Fe, Pt, Rh, Ir, Ru and Os. Most preferably, M is either Ni or Pd. Further preferably, when m is 1, E is arylene, more preferably 1,2-phenylene or 2,6-pyridenediyl. Preferred X groups are halide or hydrocarbyl, more preferably chloride, benzyl or methyl.

While the present invention is not limited to any particular theoretical mechanisms of action, it is believed that the transition metal in the unactivated metal complex exists in a square planar complex with C₂ symmetry. It is understood that the complexes may exist as dimers or in the form of a metal complex with one or more neutral Lewis base molecules.

As mentioned above, particularly preferred transition metals in accordance with the present invention include Ni and Pd. Bisthioether Ni and Pd complexes according to the present invention are especially preferred catalysts for the polymerization of olefins, providing good activity in such reactions. The lower electrophilicity of Ni and Pd (as compared to that of Ti and Zr) offers the enhanced possibility of polar comonomer incorporation into growing polymer chains. In addition, it has been found that the catalysts of the present invention, in particular Ni and Pd complexes, surprisingly can provide acceptable polymer production with the use of activators other than alumoxanes (which are relatively expensive), and that such catalysts can instead be effectively activated with co-catalysts such as trialkylaluminum compounds.

Preferred metal complexes according to the present invention are palladium dihalide complexes of bidentate thioethers containing bulky aromatic ligand groups, especially palladium dichloride salts. Examples include such derivatives of ethane-1,2-diarylthioethers, benzene-1,2-diarylthioethers, pyridine-2,6-diarylthioethers, bis(arylthioethyl)ethers, and xylene bisdiarylthio ethers, especially 1,2-bis(2,4,6-diisopropylphenylthioethane, 1,2-bis(2,4,6-diisopropylphenylthiobenzene, 2,6-bis(2,4,6-diisopropylphenylthiopyridine, bis(2,4,6-diisopropylphenylthioethyl)ether, and 1,2-bis(2,4,6-diisopropylphenylthiomethyl)benzene.

Preferred metal complexes include: 1,2-bis(2,4,6, triisopropylphenylthio)ethane palladium complexes; 2,6-bis(2,4,6-trisopropylphenylthio)pyridine palladium complexes; bis(2,4,6-triisopropylphenylthioethyl)ether palladium complexes; 1,2-(bis(2,4,6-triisopropylphenylthio)benzene palladium complexes; and benzene-1,2-(bis(2,4,6-triisopropylphenylthio)methyl) palladium complexes, depicted schematically as follows:

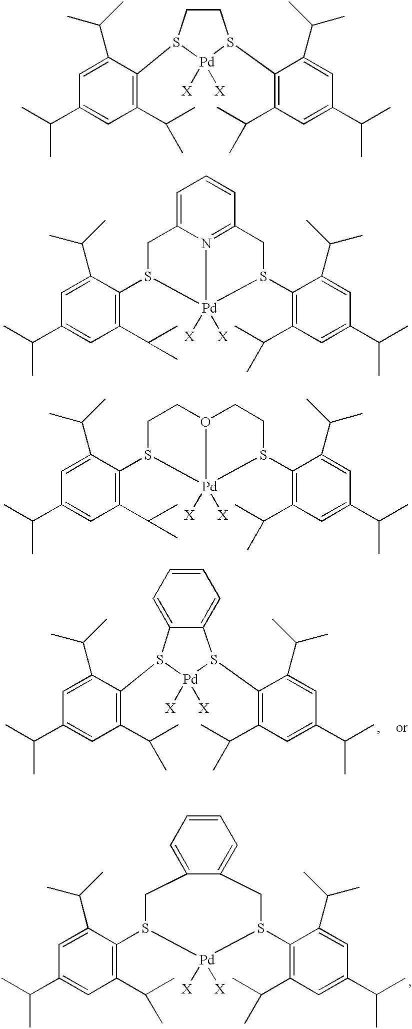

where X preferably is a halogen, methyl or benzyl group, especially chloride.

The bis(thioether) compounds according to the present invention may be prepared by reacting the corresponding thiophenol or metallated derivative thereof with a suitable dihalogenated compound, in the presence of a base. The thiophenol in turn may be prepared from the corresponding sulphonyl chloride by known techniques.

The metal complexes are prepared by contacting the bisthioether with a neutral metal compound, such as PdCl₂(C₆H₅CN)₂, or similar metal salt. Ligand exchange techniques may be employed to replace chloride X groups with any other suitable ligand.

The activating co-catalyst is capable of activating the catalyst precursor. A wide variety of activating co-catalysts are known in the art, any of which could be used in accordance with the present invention. Examples of suitable co-catalysts for use herein include linear or cyclic (co)oligomeric compounds having a formula selected from among (a), (b) and (c) set forth below in this paragraph:

(a) (M_{co-cat}R₅O)ₙ, where M_{co-cat} is a metal selected from among alkali metals, alkali earth metals, rare earth metals, aluminum and tin, aluminum being preferred, R₅ is hydrogen or a C₁- C₈ hydrocarbyl group, preferably methyl, ethyl, phenyl, or naphthyl, and n is an integer from 1 to 100;

(b) (M_{co-cat}R₆O)ₚ (M_{co-cat}R₇O)_{q}, wherein M_{co-cat} is a metal selected from among alkali metals, alkali earth metals, rare earth metals, aluminum and tin, aluminum being preferred, R₆ and R₇ are each independently selected from among hydrogen and C₁-C₈ hydrocarbyl groups, and p and q are each independently an integer from 1 to 100; and

(c) M_{co-cat}R₈, M_{co-cat}R₈R₉M_{co-cat}R₈R₉R₁₀, or M_{co-cat}R₈R₉R₁₀R₁₁, wherein M_{co-cat} is a metal selected from among alkali metals, alkali earth metals, rare earth metals, aluminum and tin, aluminum being preferred, and R₈, R₉, R₁₀ and R₁₁, where present, are each independently selected from among hydrogen, C₁- C₈ hydrocarbyl groups and C₁-C₈ alkoxy groups.

Specific preferred examples of such co-catalysts include MAO, MMAO, triethyl aluminum (TEAl) and triisobutyl aluminum (TIBA). Other specific suitable co-catalysts include compounds such as alkali metal alkyls, especially, C₁₋₄ alkyl derivatives of lithium, magnesium, zinc and tin.

Further examples of co-catalysts which can be used according to the present invention include Lewis acids able to abstract a ligand group from the metal complex while forming a non-coordinating anion. These non-coordinating anion forming activators are optional, and are most preferably employed in addition to a alumoxane or metal alkyl co-catalysts as described in the preceding paragraph. Examples of suitable non-coordinating anion forming Lewis acid activators include boron compounds of the formula B(Ar¹)₃, wherein B is boron in a valence state of 3; and Ar¹ independently each occurrence is selected from optionally substituted, C₆₋₂₀ aryl groups. Suitable aryl groups include, but are not limited to, phenyl, naphthyl and anthracenyl radicals. These radicals may be substituted one or more times with one or more organometalloid, hydrocarbyloxy, dihydrocarbylamido halogen, halocarbyl, halohydrocarbyl, or trihydrocarbylsilyl groups. Preferred substituents are fluoro groups. A preferred Lewis acid cocatalyst is tris(perflurorphenyl)borane.

Additional examples of suitable non-coordinating anion activators include compounds having the formula [LH]⁺[B(Ar¹)₄]³¹, wherein:

[LH]⁺ is a Bronsted acid;

B is boron in a valence state of 3; and

Ar¹ is as previously defined.

A final class of suitable cocatalysts include the metal hydrocarbyl halides, especially aluminum dialkyl chlorides, such as diethylaluminum chloride, diisopropylaluminum chloride.

In a further preferred aspect of the present invention, a combination of at least one Lewis acid and at least one alumoxane is used.

Co-catalysts as described above are known in the art, and can be prepared by those of ordinary skill in the art using any of a variety of known techniques. For instance, alumoxanes may be prepared in any of a variety of ways. According to one method of preparing alumoxanes, a mixture of linear and cyclic alumoxanes is obtained in the preparation of alumoxanes from, for example, trimethylaluminum and water. For example, an aluminum alkyl may be treated with water in the form of a moist solvent. Alternatively, an aluminum alkyl, such as trimethylaluminum, may be contacted with a hydrated salt, such as hydrated ferrous sulfate. The latter method comprises treating a dilute solution of trimethylaluminum in, for example, toluene with a suspension of ferrous sulfate heptahydrate. It is also possible to form methylalumoxanes by the reaction of a tetraalkyldialumoxane containing C₂ or higher alkyl groups with an amount of trimethylaluminum that is less than a stoichiometric excess. The synthesis of methylalumoxanes may also be achieved by the reaction of a trialkyl aluminum compound or a tetraalkyldialumoxane containing C₂ or higher alkyl groups with water to form a polyalkyl alumoxane, which is then reacted with trimethylaluminum. Further modified methylalumoxanes, which contain both methyl groups and higher alkyl groups, for example, isobutyl groups, may be synthesized by the reaction of a polyalkyl alumoxane containing C₂ or higher alkyl groups with trimethylaluminum and then with water as disclosed in, for example, U.S. Pat. No. 5,041,584.

The amount of catalyst usefully employed in the catalyst composition may vary within a wide range. It is generally preferred to use the catalyst compositions at concentrations sufficient to provide at least 0.000001, preferably 0.00001 percent, by weight, of transition metal based on the weight of the monomers. The upper limit of the percentages is determined by a combination of catalyst activity and process economics. When the activating cocatalyst is a branched or cyclic oligomeric poly(hydrocarbylaluminum oxide), the mole ratio of aluminum atoms contained in the poly(hydrocarbylaluminum oxide) compound to total metal atoms contained in the catalyst precursor is generally in the range of from 2:1 to 100,000:1, preferably in the range of from 10:1 to 10,000:1, and most preferably in the range of from 50:1 to 2,000:1. When the activating co-catalyst is of the formula (AlR₁₅O)ₚ (AlR₁₆O)_{q}, the mole ratio of aluminum atoms contained in the (AlR₁₅O)ₚ (AlR₁₆O)_{q} compound to total metal atoms contained in the catalyst precursor is generally in the range of from 1:1 to 100,000:1, preferably in the range of from 5:1 to 2000:1, and most preferably in the range of from 10:1 to 500:1. Likewise, suitable amounts of non-coordinating anion type co-catalysts can vary widely according to information known in the art, and based on routine evaluation by those skilled in the art. According to the present invention, non-coordinating anion co-catalysts may be used in combination with alumoxane co-catalysts, and in such circumstances, there is no minimum amount of non-coordinating anion required.

The catalyst composition may optionally contain one or more other polyolefin catalysts. These catalysts include, for example, any Ziegler-Natta catalysts containing a metal from groups IV(B), V(B), or VI(B) of the Periodic Table. Suitable activators for Ziegler-Natta catalysts are well known in the art and may also be included in the catalyst composition.

The catalyst precursor and the activating co-catalyst may be independently or simultaneously (a) impregnated onto a solid support, (b) in liquid form such as a solution or dispersion, (c) spray dried with a support material, (d) in the form of a prepolymer, or (e) formed in the reactor in-situ during polymerization.

For example, in one suitable aspect, the support may first be impregnated with a hydrocarbon solution of the co-catalyst, dried of solvent followed by reimpregnation with the metal catalyst solution followed by solvent removal. Alternatively, the base support may be impregnated with the reaction product of the metal catalyst precursor and the co-catalyst followed by removal of the solvent. In either case, a hydrocarbon slurry of the supported, activated catalyst or a hydrocarbon-free powder results and these are used, usually without added activator as olefin polymerization catalysts. Frequently, an impurity scavenger is added to the reaction prior to or along with the catalyst-cocatalyst slurry/powder in order to maximize its activity. Alternatively, the support can first be heated to drive off hydroxylic impurities notably water followed by reaction of the remaining hydroxyl groups with proton scavengers such as hydrocarbyl aluminum compounds (TMA, TEA, TIBAL, TNHAL, MAO, MMAO, etc.). Also, the heating may be omitted and the support reacted directly with the hydrocarbyl aluminum compounds. In another preferred aspect, the catalyst precursor is dissolved in a solvent, a cocatalyst is then added to the dissolved catalyst precursor, and the resulting product is introduced into a reactor via a feeding line. Another preferred aspect involves mixing the catalyst precursor with a cocatalyst solution in a solvent (for example, an organic solvent such as toluene), adding a support material, such as silica, removing solvent (such as by drying in a vacuum or heating), and introducing the resulting product into a reactor via a feeding line either as a solid feed or slurry in a liquid such as hexane.

In the case of impregnation on a support, the activating co-catalyst and/or catalyst precursor may be impregnated in or deposited on the surface of an inert substrate such as silicon dioxide (silica), aluminum oxide (alumina), carbon black, polyethylene, polycarbonate, polystyrene, zinc oxide, polypropylene, thoria, zirconia, or magnesium halide, especially magnesium dichloride, and mixtures thereof, such that the catalyst composition is between 0.1 and 90 percent by weight of the total weight of the catalyst composition and the support. These supports preferably have been calcined at a temperature sufficient to remove substantially all physically bound water. Conventional techniques, such as those disclosed in U.S. Pat. No. 4,521,723, can be employed for impregnating the activating co-catalyst and/or catalyst precursor onto a catalyst support.

A preferred support material is a silica material. For example, some such materials are described in U.S. Pat. No. 5,264,506. Desirably, the silica support has an average particle size of from 60 to 200 (preferably 70 to 140) microns; preferably, no more than 30 percent by weight silica should have a particle size below 44 microns. Further, the silica support has an average pore diameter of greater than 100 Angstrom units, preferably greater than 150 Angstrom units. It is also desirable for the silica support to have a surface area greater than 200 square meters per gram. The support is preferably substantially dry, that is, free of adsorbed water. Drying of the silica may be carried out by heating it at a temperature of from 100 to 800° C.

Suitable liquid form catalyst compositions are described in U.S. Pat. No. 5,317,036. Unsupported liquid form catalyst compositions which include liquid catalyst precursor, liquid co-catalyst, solution(s) or dispersion(s) thereof in the same or different solvent(s), and combinations thereof, can have a number of practical benefits. Unsupported catalyst compositions avoid the costs associated with support material and its preparation, and can provide for the realization of a very high catalyst surface area to volume ratio. Furthermore, unsupported catalyst compositions produce polymers which usually have a much lower residual ash content then polymers produced using supported catalyst compositions.

Spray-drying may be effected by any spray-drying method known in the art. Spray-drying can be useful to provide catalysts having a narrow droplet size distribution (and resulting narrow particle size distribution) for efficient use of the catalyst and to give more uniform pellets and better performance, in addition to having beneficial morphology.

For example, one example of a suitable spray-drying method comprises atomizing a solution, suspension or dispersion of the catalyst and/or the activating co-catalyst, optionally together with a filler, and optionally with heating of the solution, suspension or dispersion. Atomization is accomplished by means of any suitable atomizing device to form discrete spherically shaped particles. Atomization is preferably effected by passing the slurry through the atomizer together with an inert drying gas, that is, a gas which is nonreactive under the conditions employed during atomization, especially nitrogen. An atomizing nozzle or a centrifugal high speed disc can be employed to effect atomization, whereby there is created a spray or dispersion of droplets of the mixture. The volumetric flow of drying gas, if used, preferably considerably exceeds the volumetric flow of the slurry to effect atomization of the slurry and/or evaporation of the liquid medium. Ordinarily the drying gas is heated to a temperature as high as 160° C. to facilitate atomization of the slurry; however, if the volumetric flow of drying gas is maintained at a very high level, it is possible to employ lower temperatures. Atomization pressures of from 1 psig to 200 psig (100 kPa to 1.4 MPa) are suitable. Some examples of suitable spray-drying methods include those disclosed in U.S. Pat. Nos. 5,290,745, 5,652,314, 4,376,062, 4,728,705, 5,604,172, 5,306,350 and 4,638,029.

Another type of suitable spray-drying method comprises forming a liquid mixture comprising a nonvolatile materials fraction, a solvent fraction and at least one compressed fluid; and spraying the liquid mixture at a temperature and pressure that gives a substantially decompressive spray by passing the mixture through an orifice into an environment suitable for forming solid particulates by solvent evaporation. For example, such a method is disclosed in U.S. Pat. No. 5,716,558.

In general, spray-drying produces discrete, substantially round, abrasive resistant particles with relatively narrow particle size distribution. By adjusting the size of the orifices of the atomizer employed during spray drying, it is possible to obtain particles having desired average particle size, especially from 5 micrometers to 200 micrometers.

As mentioned above, catalyst precursor and/or activating co-catalyst may be in the form of a prepolymer. Such prepolymers can be formed in any suitable manner, such as by forming one or more polymer or copolymer (which may be the same or different from the polymer(s) and/or copolymer(s) to be collected in the reactor) in the presence of the catalyst precursor and/or activating co-catalyst. For example, processes which provide catalyst precursor and/or activating co-catalyst attached to and at least partially covered by polymeric and/or copolymeric material may be suitable.

The catalyst system may optionally be treated with an amine activator. By adding an amine to the catalyst precursor and then subsequently adding the cocatalyst, some catalyst systems yield higher activities than when no amine pretreatment occurs or when the amine treatment is added to the catalyst system containing both the precursor and cocatalyst. Indeed, this latter treatment has even yielded an inhibited catalyst system from an activity perspective. The level of amine addition ranges from 0.1 to 10 moles of amine per mole of transition metal, preferably from 1 to 5 moles amine per mole of transition metal. Suitable amines include, but are not limited to, ethyl amine, diethyl amine, triethyl amine, and piperidine.

The catalyst composition may be used for the polymerization of olefins by any suspension, solution, slurry, or gas phase process, using known equipment and reaction conditions, and is not limited to any specific type of reaction system. Such polymerization can be conducted in a batchwise mode, a continuous mode, or any combination thereof. Generally, suitable olefin polymerization temperatures are in the range of from 0° C. to 200° C. at atmospheric, subatmospheric, or superatmospheric pressures.

Preferably, gas phase polymerization is employed, at superatmospheric pressure in the range of from 70 kPa to 7 MPa (1 to 1000 psi), preferably 350 kPa to 2.8 MPa (50 to 400 psi), most preferably 799 kPa to 2 MPa (100 to 300 psi), and at temperatures in the range of from 30° C. to 130° C., preferably 65° C. to 110° C. Stirred or fluidized bed gas phase reaction systems are particularly useful. Generally, a conventional gas phase, fluidized bed process is conducted by passing a stream containing one or more olefin monomers continuously through a fluidized bed reactor under reaction conditions sufficient to polymerize the monomer(s) and in the presence of an effective amount of catalyst composition at a velocity sufficient to maintain a bed of solid particles in a suspended condition. A stream containing unreacted monomer is withdrawn from the reactor continuously, compressed, cooled, optionally fully or partially condensed as disclosed in U.S. Pat. Nos. 4,543,399, 4,588,790, 5,352,749 and 5,462,999, and recycled to the reactor. Product is withdrawn from the reactor and make-up monomer is added to the recycle stream. In addition, a fluidization aid such as carbon black, silica, clay, or talc may be used, as disclosed in U.S. Pat. No. 4,994,534. Suitable gas phase reaction systems are also described in U.S. Pat. No. 5,527,752.

Slurry or solution polymerization processes may utilize subatmospheric or superatmospheric pressures and temperatures in the range of from 40° C. to 110° C. Useful solution or slurry polymerization reaction conditions are described in U.S. Pat. Nos. 3,324,095, 5,453,471, 5,527,752, 5,834,571, WO 96/04322 and WO 96/04323. Liquid phase reaction systems generally comprise a reactor vessel to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, and toluene. Reactive contact between the olefin monomer and the catalyst composition should be maintained by constant stirring or agitation. Preferably, reaction medium containing the olefin polymer product and unreacted olefin monomer is withdrawn continuously from the reactor. Olefin polymer product is separated, and unreacted olefin monomer is recycled into the reactor.

Polymerization may be carried out in a single reactor or in two or more reactors in series. Where tandem reactors are employed (for example, two or more reactors in series), the reactors may each have a unique set of reaction conditions, that is, one or more reaction condition is different in one reactor relative to one or more other reactor. The use of different conditions in different reactors, can be useful where a broadening of the product molecular weight distribution is desired.

Polymerization is preferably conducted substantially in the absence of undesirable catalyst poisons, such as moisture, oxygen, carbon monoxide, carbon dioxide, and acetylene. Organometallic compounds may be employed as scavenging agents for removal of poisons, when necessary, to increase catalyst activity. Examples of scavenging agents include metal alkyls, preferably aluminum alkyls, most preferably triusobutylaluminum or tri-n-hexyl aluminum. As noted above, however, the present invention provides catalyst precursor compounds and catalyst compositions which have good resistance to such catalyst poisons.

Conventional adjuvants may be included in the process, provided they do not interfere with the operation of the catalyst composition in forming the desired polyolefin. If desired, hydrogen or a metal or non-metal hydride, such as a silyl hydride, may be used as a chain transfer agent in the process. Where desired, hydrogen may be used preferably in amounts up to 10 moles of hydrogen per mole of total monomer feed, although as mentioned above, it is preferred that the reactants and the catalyst of the present invention be free of or substantially free of hydrogen.

As desired for temperature control of the system, any gas inert to the catalyst composition and reactants may also be present in the gas stream.

Other conventional additives may be included in the process, provided they do not interfere with the operation of the catalyst composition in forming the desired polyolefin. For example, other additives which may be introduced into one or more streams entering polymer formulation include antioxidants, coupling agents, ultraviolet absorbers or stabilizers, themo- or photo-oxidation stabilizers including hindered phenolic and hydroxy amino antioxidants, hindered amine light stabilizers, thioesters, disulfide phosphites, aryl phosphites, or phosphonites, colorants (including carbon blacks and titanium dioxide), antistatic agents, pigments, dyes, nucleating agents, reinforcing fillers or polymer additives, slip agents, plasticizers, processing aids (for example fluoroelastomers), lubricants (especially metallic stearates), slip agents (such as oleamide or erucamide), viscosity control agents, tackifiers, antiblock or release agents (for example, stearamide, ethylene bis-stearamide, controlled particle size zeolite, calcium carbonate, talc or silica), blowing agents, surfactants, extenders oils, metal deactivators, voltage stabilizers, flame retardants, crosslinking agents, boosters, catalysts, Lewis bases (see U.S. Pat. No. 5,527,752) and smoke suppressants. Fillers and additives can be added in amounts ranging from less than 0.1 to more than 200 parts by weight for each 100 parts by weight of the base resin, for example, polyethylene.

Examples of antioxidants are: hindered phenols such as tetrakis[methylene(3,5-di-tert-butyl-4-hydroxyhydrocinnamate)]methane, bis[(beta-(3,5-di-tert-butyl-4-hydroxybenzyl)-methyl-carboxyethyl)]sulphide, 4,4′-thiobis(2-methyl-6-tert-butylphenol), 4,4′-thio-bis(2-tert-butyl-5-methyl-phenol), 2,2′-thiobis(4-methyl-6-tert-butylphenol), and thiodiethylene bis(3,5-di-tert-butyl-4-hydroxy)hydrocinnamate; phosphites and phosphonites such as tris(2,4-di-tert-butylphenyl) phosphite and di-tert-butylphenyl-phosphonite; thio compounds such as dilaurylthiodipropionate, dimyristylthiodipropionate, and distearylthiodipropionate; various siloxanes; and various amines such as polymerized 2,2,4-trimethyl-1,2-dihydroquinoline. Antioxidants can be used in amounts of 0.1 to 5 parts by weight per 100 parts by weight of polyethylene.

Olefin polymers and copolymers that may be produced according to the invention include, but are not limited to, ethylene homopolymers, homopolymers of linear or branched higher alpha-olefins containing 3 to 20 carbon atoms, and copolymers of olefin (preferably ethylene) and (a) higher alpha-olefins, (b) cyclic olefins or (c) alpha olefin-dienes. Suitable higher alpha-olefins include, for example, propylene, 1-butene, 1-pentene, 1-hexene, 4-methyl-1-pentene, 1-octene, and 3,5,5-trimethyl-1-hexene. Suitable cyclic olefins include, for example, norbornene and styrene. Suitable alpha olefin-dienes include linear, branched, or cyclic hydrocarbon dienes having from 4 to 20, preferably 4 to 12, carbon atoms. Preferred dienes include 1,4-pentadiene, 1,5-hexadiene, 5-vinyl-2-norbomene, 1,7-octadiene, vinyl cyclohexene, dicyclopentadiene, butadiene, isobutylene, isoprene, and ethylidene norbornene. Other suitable monomers include olefins having one or more strained double bonds such as bicyclo (2.2.1) hepta-2,5-diene, 5-ethylidine-2-norbornene, 5-vinyl-2-norborene (endo and exo forms or mixtures thereof) and normal mono-olefins.

Aromatic compounds having vinyl unsaturation such as styrene and substituted styrenes, and polar vinyl monomers such as acrylonitrile, maleic acid esters, vinyl acetate, acrylate esters, methacrylate esters, vinyl trialkyl silanes and the like may be polymerized according to the invention as well.

Specific olefin polymers that may be made according to the invention include, for example, polyethylene, polypropylene, or polybutylene, ethylene/α-olefin copolymers such as ethylene/propylene (EP) or ethylene/propylene/diene terpolymers (EPDM), ethylene/cycloolefin copolymers, such as, ethylene/cyclohexene copolymers, polybutadiene, and polyisoprene. A wide variety of olefin polymers can be produced according to the present invention, with a preferred olefin polymer being ethylene homopolymers and ethylene/1-butene or ethylene/1-hexene copolymers. Preferably polymers prepared according to the present invention are of relatively high molecular weight, typically in the range of from 10,000 to 10,000,000.

As mentioned above, the present invention offers the possibility of incorporating polar comonomer into growing polymer chains.

Polymers produced by methods according to the present invention can be crosslinked by adding a crosslinking agent to the composition or by making the resin hydrolyzable, by adding hydrolyzable group. Suitable cross-linking agents are organic peroxides such as dicumyl peroxide; 2,5-dimethyl-2,5-di(t-butylperoxy)hexane; t-butyl cumyl peroxide; and 2,5-dimethyl-2,5-di(t-butylperoxy)hexane-3. Dicumyl peroxide is preferred. Hydrolyzable groups can be added to polymers produced by methods according to the present invention, for example, by copolymerizing ethylene with an ethylenically unsaturated compound having one or more —Si(OR)₃ groups such as vinyltrimethoxy-silane, vinyltriethoxysilane, and gamma-methacryloxypropyltrimethoxysilane or grafting these silane compounds to the resin in the presence of the aforementioned organic peroxides. The hydrolyzable resins are then crosslinked by moisture in the presence of a silanol condensation catalyst such as dibutyltin dilaurate, dioctyltin maleate, dibutyltin diacetate, stannous acetate, lead naphthenate, and zinc caprylate. Dibutyltin dilaurate is preferred.

Examples of hydrolyzable copolymers and hydrolyzable grafted copolymers are ethylene/vinyltrimethoxy silane copolymer, ethylene/gamma-methacryloxypropyltrimethoxy silane copolymer, vinyltrimethoxy silane grafted ethylene/ethyl acrylate copolymer, vinyltrimethoxy silane grafted linear low density ethylene/l-butene copolymer, and vinyltrimethoxy silane grafted low density polyethylene.

As indicated above, the present invention is further directed to blown and cast films including clarity and shrink applications, extrusion coatings, wire and cable insulation and jacketing, crosslinked power cable insulation, molded articles made by injection molding, blow molding or rotational molding, extrusions of pipe, tubing, profiles and sheeting, and insulating and semiconductive jacketing and/or shields, etc., made from olefin polymers produced using the catalyst precursors, catalyst compositions and/or catalyst systems described above. Methods of making these and other products are well known in the art.

It is understood that the present invention is operable in the absence of any component which has not been specifically disclosed. The following examples are provided in order to further illustrate the invention and are not to be construed as limiting. Unless stated to the contrary, all parts and percentages are expressed on a weight basis. The term “overnight”, if used, refers to a time of approximately 16 to 18 hours, “room temperature”, if used, refers to a temperature of 20 to 25° C. All syntheses and manipulations of air-sensitive materials were carried out in an inert atmosphere (nitrogen or argon) glove box. Solvents preferably are first saturated with nitrogen and then dried by passage through activated alumina prior to use.

### EXAMPLE 1

Synthesis of 1,2-bis(2,4,6, triisopropylphenylthio)ethane)

A round bottom flask was charged with 1,2-dibromoethane (9.75 mmol; 0.84 mL), 2,4,6-triisopropylthiophenol (19.5 mmol; 4.60 g), sodium hydroxide (19.5 mmol; 4.60 g) and ethanol (100 mL). After stirring for 3 hours at room temperature, a white solid precipitated from solution. Removal of the volatiles gave a pale yellow solid which was extracted with hexane and then pumped down to dryness. Ethanol (2 mL) was added, giving a white flocculent material, which was collected onto a fritted funnel, and dried under reduced pressure. Yield: 2.36 g, 50 percent.

### EXAMPLE 2

Synthesis of 2 6-bis(2 4,6-triisopropylphenylthiomethyl)pyridine

To a solution of 2,6-bis(bromomethyl)pyridine (5 mmol; 1.325 g) in Et₂O (40 mL) was added a solution of lithium-(2,4,6-triisopropylthiophenol) (prepared by reaction of butyllithium with 2,4,6-triisopropylthiophenol in hexane at −25° C., 10 mmol; 2.42 g) in Et₂O (40 mL). The reaction was allowed to stir overnight at room temperature. The colorless solution was evaporated to dryness, extracted with 200 mL hexane and filtered through diatomaceous earth. Removal of the volatiles gave fluffy colorless crystals, which were collected onto a fritted disk and dried under reduced pressure. Yield: 2.2 g, 71 percent.

### EXAMPLE 3

Synthesis of bis-(2,4,6-triisopropylphenylthioethyl)ether

The reaction conditions of Example 2 were substantially repeated using bis(2-bromoethyl)ether in place of 2,6-bis(bromomethyl)pyridine.

### EXAMPLE 4

Synthesis of 1,2-bis(2,4,6-triisopropylphenylthiomethyl)benzene

The reaction conditions of Example 2 were substantially repeated using 1,2-dibromomethylbenzene in place of 2,6-bis(bromomethyl)pyridine.

### EXAMPLE 5

Synthesis of 1,2-bis(2,4,6 triisopropylphenylthio)ethane palladium dichloride

PdCl₂(C₆H₅CN)₂ (3 mmol; 1.15 g) was added as a solid to a solution of 1,2-bis(2,4,6, triisopropylphenylthio)ethane (3 mmol; 1.5 g) in 80 mL CH₂Cl₂. The reaction mixture was stirred over the weekend at room temperature and then filtered through diatomaceous earth. After concentration of the solution to about 10 mL, 200 mL n-hexane was added causing the precipitation of an orange powder. The solids were collected onto a fritted disk, and dried under reduced pressure. Yield: 1.45 g; 71 percent. The complexes were recrystallized from the slow diffusion of hexane into a saturated methylene chloride solution containing the complex.

### EXAMPLE 6

Synthesis of 2,6-bis(2,4,6-triisopropylphenylthiomethyl)pyridine palladium dichloride

The reaction conditions of Example 5 were substantially repeated using 2,6-bis((2,4,6-triisopropylphenylthio)methyl)pyridine in place of 1,2-bis(2,4,6, triisopropylphenylthio)ethane.

### EXAMPLE 7

Synthesis of bis-(2,4,6-triisopropylphenylthioethyl)ether palladium dichloride

The reaction conditions of Example 5 were substantially repeated using bis-(2,4,6-triisopropylphenylthioethyl)ether in place of 1,2-bis(2,4,6, triisopropylphenylthio)ethane.

### EXAMPLE 8

Synthesis of 1,2-bis(2,4,6-triisopropylphenylthiomethyl)benzene palladium dichloride

The reaction conditions of Example 5 were substantially repeated using bis-(2,4,6-triisopropylphenylthiomethyl)benzene for 1,2-bis(2,4,6, triisopropylphenylthio)ethane.

### EXAMPLE 9

Synthesis of 1,2-bis(2,4,6, triisopropylphenylthio)ethanepalladium dichloride [tris(pentafluorophenyl)borane]₂ complex

To a solution of 1,2-bis(2,4,6, triisopropylphenylthio)ethanepalladium dichloride (0.25 mmol; 0.168 g) in a minimal volume of toluene (2 mL) was added a solution of B(C₆F₅)₃ (0.50 mmol; 0.206 g) in 1 mL toluene. The solution was stirred for one minute to dissolve the solids and then allowed to sit at room temperature overnight. The orange crystals were collected onto a fritted disk and dried under reduced pressure. Yield: 0.407 g; 100 percent.

### EXAMPLE 10

Synthesis of 1,2-bis(2,4,6, triisopropylphenylthio)ethanepalladium dichloride [tris(pentafluorophenyl)borane] complex

The reaction conditions of Example 9 were substantially repeated using a 1:1 molar ratio of tris(pentafluorophenyl)borane to palladium salt.

### EXAMPLE 11

Synthesis of SiO₂ supported 1,2-bis(2,4,6, triisopropylphenylthio)ethane palladium dichloride [tris(pentafluorophenyl)borane]₂ complex

1,2-bis(2,4,6, triisopropylphenylthio)ethanepalladium dichloride bis[tris(pentafluorophenyl)borane] complex (example 9) was slurried with previously dried (200° C., one hour) SiO₂ in hexane. The liquid was removed under reduced pressure to give a supported catalyst composition.

Slurry Polymerizations

A 1 liter stirred autoclave reactor was charged with 485 ml hexane, MMAO cocatalyst, and 9 μmole of metal complex. Hexene, if used, was added. The reactor was pressurized H₂ (about 140 kPa, 5 psig) and the temperature was raised to 65° C. (60° C. in Run 3). Ethylene was supplied to maintain a reactor pressure of 1.4 MPa (200 psig), and the temperature was controlled at 65° C. (60° C. in Run 3). After 30 minutes, ethylene feed was stopped, the reactor was cooled and vented, and granular high-density polyethylene was recovered. The results are shown in Table 1:

TABLE 1

| | | | Al:Pd | | | |
|---|---|---|---|---|---|---|
| Run | Catalyst | Activity¹ | Molar Ratio | hexene | FI² | MFR³ |
| 1 | Ex. 5 | 0.5 | 494:1 | 0 | 5.9 | 16 |
| 2 | Ex. 11 | 5.4 | 1504:1 | 0 | 8.8 | 15.5 |
| 3 | Ex. 9 | 1.3 | 164:1 | 0 | — | — |
| 4 | Ex. 7 | 7.0 | 452:1 | 0 | — | — |
| 5 | Ex. 10 | 2.9 | 271:1 | 50 mL | 2.8 | 23 |
| 6 | Ex. 10 | 8.9 | 256:1 | 0 | 7.3 | 17 |
| 7 | Ex. 8 | 2.1 | 271:1 | 0 | — | — |

¹kg polymer/mmol Pd × hr × 0.7 MPa C₂H₄;
²FI (flow index) was determined according to ASTM D-1238, Condition F
³MFR (melt flow ratio) is the ratio of FI to melt index, melt index being determined according to ASTM D-1238, Condition E.

Gas Phase Polymerization

A 1-liter, stirred, gas-phase reactor, operating at 65° C. and 1.4 MPa (200 psig) ethylene pressure was used to prepare high molecular weight, high density ethylene homopolymer using the supported catalyst of Example 11. MMAO added to the reactor contents was used as the co-catalyst. The resulting polymer had residual Pd content of 28 ppm, flow index (ASTM D-1238, Condition F) of 0, average resin particle size of 1 mm (0.05 inch), bulk density of 290 kg/m³ (18 lb/ft³), Mw=567,000, Mn=51,000, and polymer density or 0.943.

1. A metal complex comprising a bidentate or tridentate, dithioether ligand corresponding to the formula: 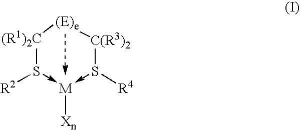
wherein:
E is a divalent ligand group containing one or more Group 14, 15 or 16 elements and optionally E may be bonded to M, said optional bond being indicated by →, and further optionally, (R¹)₂C-(E)ₑ-C(R³)₂ collectively may be a 1,2-benzenediyl group;
e is 0 or 1;
M is a transition metal selected from groups 3-10 of the Periodic Table of the Elements;
R¹, R², R³ and R⁴ each occurrence are hydrogen, halogen, or a multiatomic group of up to 20 atoms not counting hydrogen, selected from the group consisting of hydrocarbyl; halocarbyl; halohydrocarbyl; hydrocarbyloxy; N,N-dihydrocarbylamino; N,N-hydrocarbyleneamino; dihydrocarbylphosphino; hydrocarbylenephosphino; trihydrocarbylsilyl; trihyhdrocarbylgermyl; and dihydrocarbylamino-, dihydrocarbylphosphino-, trihydrocarbylsilyl-, or trihalohydrocarbylsilyl- substituted derivatives thereof, and optionally R¹ may be joined to R², and further optionally R³ may be joined to R⁴, thereby forming ring structures;
X is a monovalent or divalent ligand group; and
n is an integer from 2 to 4 selected to provide charge balance.

2. The metal complex of claim 1, wherein R² and R⁴ are each an aryl group of from 6 to 20 carbons, M is Ni, Pd, Co, Fe, Pt, Rh, Ir, Ru or Os, e is 1, E is oxygen, 1,2-phenylene or 2,6-pyridenediyl, and X is halide or hydrocarbyl.

3. The metal complex of claim 1 wherein R² and R⁴ each occurrence are 2,4,6-triisopropylphenyl, 2,6-diisopropylphenyl, 2,6-di-t-butylphenyl, or 2,4,6-trimethylphenyl, M is Ni or Pd, e is 1, E is oxygen, 1,2-phenylene or 2,6-pyridenediyl, and X is chloride.

4. The metal complex of claim 1 which is a 1,2-bis(2,4,6, triisopropylphenyl-thio) ethane palladium complex; a 2,6-bis(2,4,6-triisopropylphenylthio)pyridine palladium complex; a bis(2,4,6-triisopropylphenylthioethyl)ether palladium complex; a 1,2-(bis(2,4,6-triisopropylphenylthio)benzene palladium complex; or a 1,2-bis(2,4,6-triisopropylphenylthiomethyl)benzene palladium complex.

5. The metal complex of claim 1 wherein X each occurrence is chloride.

6. A catalyst composition comprising the metal complex of claim 1 and an activating cocatalyst.

7. The catalyst composition of claim 6 additionally comprising a support.

8. A process for producing an olefin polymer, which comprises contacting at least one olefin monomer under polymerization conditions with a catalyst composition according to claim 6 or 7.
